(19) United States
(12) Patent Application Publication
(10) Pub. No.: US 2018/0117437 A1
(43) Pub. Date: May 3, 2018

(54) Swimming Stroke Adjustment Device, Swimming Stroke Information Processing System and Method

(71) Applicant: BOE TECHNOLOGY GROUP CO., LTD., Beijing (CN)

(72) Inventors: Tianyue ZHAO, Beijing (CN); Lu TONG, Beijing (CN)

(21) Appl. No.: 15/797,092

(22) Filed: Oct. 30, 2017

(30) Foreign Application Priority Data
Nov. 3, 2016 (CN) 201610959445.1

(51) Int. Cl. A63B 69/12; A63B 24/00; G09B 19/00; A63B 71/06; A41D 7/00; A41D 1/00

(52) U.S. Cl. CPC A63B 69/12; A63B 24/0006; A63B 24/0062; G09B 19/0038; A63B 71/0622; A41D 7/00; A63B 2220/836; A63B 2208/03; A63B 2024/0015; A63B 2225/50; A63B 2071/063; A63B 2071/0655; A41D 1/002

(57) ABSTRACT

The present application discloses a swimming stroke adjusting device, a swimming stroke information processing system and a swimming stroke information processing method. The swimming stroke adjusting device includes an acquiring device configured to acquire swimming stroke information of limb positions to be detected of a user; and a prompt information. determination processor configured to determine, according to the swimming stroke information, prompt information for prompting the user to adjust swimming strokes.

### CROSS-REFERENCE TO RELATED APPLICATION

This application claims priority benefit from Chinese Application No. 201610959445.1, filed on Nov. 3, 2016, the content of which is hereby incorporated by reference by its entirety.

### TECHNICAL FIELD

The present disclosure relates to the field of computer technology, and particularly relates to a swimming stroke adjustment device, a swimming stroke information processing system and a swimming stroke information processing method.

### BACKGROUND

Many people are afraid of learning swimming for lack of guidance on swimming strokes, or can only swim simply with rather non-standard swimming strokes. Currently, in the technical field of swimming stroke adjustment, intelligent swimming apparatuses for guiding a user to adjust his/her swimming strokes have become a hot area of research.

### SUMMARY

The present disclosure proposes a swimming stroke adjustment device, a swimming stroke information processing system, and a swimming stroke information processing method, for the purpose of adjusting swimming strokes of a user and correcting swimming strokes of the user in different swimming styles.

In one aspect, the present disclosure provides a swimming stroke adjustment device, comprising: an acquiring device, configured to acquire swimming stroke information of limb positions to be detected of a user, and a prompt information determination processor, configured to determine, according to the swimming stroke information, prompt information for prompting the user to adjust swimming strokes.

Optionally, the prompt information determination processor is configured to determine a swimming stroke model of the user according to the swimming stroke information, and compare the determined swimming stroke model with a standard swimming stroke model to determine the prompt information.

Optionally, the acquiring device comprises a spacing acquiring device for acquiring a spacing between the limb positions to be detected.

Optionally, the acquiring device comprises an angle acquiring device for acquiring an angle at the limb positions to be detected.

Optionally, the limb positions to be detected comprise at least one of feet, knees and elbows;

the spacing acquiring device is configured to acquire at least one of foot spacing, knee spacing and elbow spacing; and

the prompt information is used for prompting the user o adjust at least one of the foot spacing, the knee spacing and the elbow spacing.

Optionally, the limb positions to be detected comprise at least one of palms and soles;

the angle acquiring device is configured to acquire at least one of a palm tilt angle and a sole tilt angle; and

the prompt information is used for prompting the user to adjust at least one of the palm tilt angle and the sole tilt angle.

Optionally, the angle acquiring device is configured to acquire at least one of elbow bending angle information and knee bending angle information, and

the prompt information is used for prompting the user to adjust at least one of an elbow bending angle and a knee bending angle.

Optionally, the angle acquiring device is configured to: acquire position information at each elbow, a position in each forearm and a position in each upper arm and determine the elbow bending angle information based on the acquired position information at each elbow, the position in each forearm and the position in each upper arm; and/or acquire position information at each knee, a position in each shank and a position in each thigh and determine the knee bending angle information based on the acquired position information at each knee, the position in each shank and the position in each thigh.

In another aspect, the present disclosure provides a swimming stroke information processing system, comprising the foregoing swimming stroke adjustment device and a prompt information output device connected to the swimming stroke adjustment device in wireless or wired manner.

Optionally, the prompt information determination processor is configured to determine a swimming stroke model of the user according to the swimming stroke information, and compare the determined swimming stroke model with a standard swimming stroke model to determine the prompt information.

Optionally, the prompt information output device comprises one or more of a display device, a drive device and an audio device;

the display device is configured to display, according to the prompt information, comparative images comprising the determined swimming stroke model of the user and the standard swimming stroke model to the user, so that the user adjusts the swimming strokes according to the comparative images;

the drive device is configured to generate, according to the prompt information, a force for impelling limbs of the user to move in a direction indicated by the standard swimming stroke model, so that the user adjusts the swimming strokes; and

the audio device is configured to generate, according to the prompt information, voice information for informing the user of incorrect swimming stroke, so that the user adjusts the swimming strokes.

In another aspect, the present disclosure provides a swimming stroke information processing method, comprising steps of: acquiring swimming stroke information of limb positions to be detected of a user, and determining, according to the swimming stroke information, prompt information for prompting the user to adjust swimming strokes.

Optionally, the step of determining the prompt information according to the swimming stroke information comprises determining a swimming stroke model of the user according to the swimming stroke information, and comparing the determined swimming stroke model with a standard swimming stroke model to determine the prompt information.

Optionally, the step of acquiring swimming stroke information of limb positions to be detected of the user comprises acquiring a spacing between the limb positions to be detected.

Optionally, the step of acquiring swimming stroke information of limb positions to be detected of the user comprises acquiring an angle at the limb position to be detected.

Optionally, the limb positions to be detected comprise at least one of feet, knees and elbows;

the step of acquiring swimming stroke information of limb positions to be detected of the user comprises acquiring at least one of foot spacing, knee spacing and elbow spacing; and

the prompt information is used for prompting the user to adjust at as one of the foot spacing, the knee spacing and the elbow spacing.

Optionally, the limb positions to be detected comprise at least one of palms and soles;

the step of acquiring swimming stroke information of limb positions to be detected of the user comprises acquiring at least one of a palm tilt angle and a sole tilt angle; and

the prompt information is used for prompting the user to adjust at least one of the palm tilt angle and the sole tilt angle.

Optionally, the step of acquiring swimming stroke information of limb positions to be detected of the user comprises acquiring at least one of elbow bending angle information and knee bending angle information, and

the prompt information is used for prompting the user to adjust at least one of an elbow bending angle and a knee bending angle.

Optionally, the step of acquiring swimming stroke information of limb positions to be detected of the user comprises: acquiring position information at each elbow, a position in each forearm and a position in each upper arm and determining the elbow bending angle information based on the acquired position information at each elbow, the position in each forearm and the position in each upper arm; and/or acquiring position information at each knee, a position in each shank and a position in each thigh and determining the knee bending angle information based on the acquired position information at each knee, the position in each shank and the position in each thigh.

Optionally, the prompt information is output to the user in at least one of the following ways:

outputting the prompt information in audio form;

outputting the prompt information in video form; and

outputting forces for impelling limbs of the user in a direction indicated by the standard swimming stroke model.

### BRIEF DESCRIPTION OF THE FIGURES

In order to explain technical solutions in embodiments of the present disclosure more clearly, drawings of the embodiments will be briefly described below. Obviously, the drawings described as follows only relate to some embodiments of the present disclosure, and are not intended to limit the present disclosure.

FIG. 1 is a schematic diagram illustrating limbs of a person in freestyle swimming.

FIG. 2 is a schematic flow chart of a swimming stroke information processing method according to some embodiments of the present disclosure.

FIG. 3 is a schematic flow chart of a swimming stroke information processing method according to some embodiments of the present disclosure.

FIG. 4 is a schematic block diagram of a swimming stroke adjustment device according to some embodiments of the present disclosure.

FIG. 5 is a schematic block diagram of a swimming stroke adjustment device according to some embodiments of the present disclosure.

FIG. 6 is a schematic block diagram of a swimming stroke adjustment device according to some embodiments of the present disclosure.

FIG. 7 is a schematic block diagram of a swimming stroke information processing system according to some embodiments of the present disclosure.

### DETAILED DESCRIPTION

Technical solutions in embodiments of the present disclosure will be described clearly and thoroughly below in conjunction with accompanying drawings. Obviously, the embodiments to be described are not all of, but only part of the embodiments of the present disclosure. All other embodiments, which are obtained by an ordinary person skilled in the art without any creative effort based on the embodiments in the present disclosure, should fall into the protection scope of the present disclosure.

Swimming styles general include freestyle, breaststroke, butterfly and so on. In one swimming style, limbs of a person move cyclically and movements at positions of the limbs of the person are also cyclical when swimming. Typical positions include positions at hands, upper arms, elbows, thighs, knees, and feet.

FIG. 1 is a schematic diagram illustrating limbs of a person in freestyle swimming. As shown in FIG. 1, movement trajectories of hands, upper arms, elbows, thighs, knees, and feet of one person are cyclical in standard freestyle swimming. For example, in an ideal case, hands make paddling movements cyclically at standard angles, elbows bend cyclically at standard angles, etc.

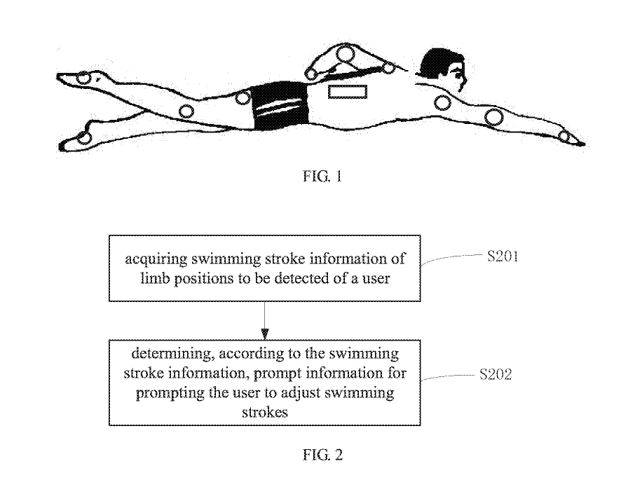

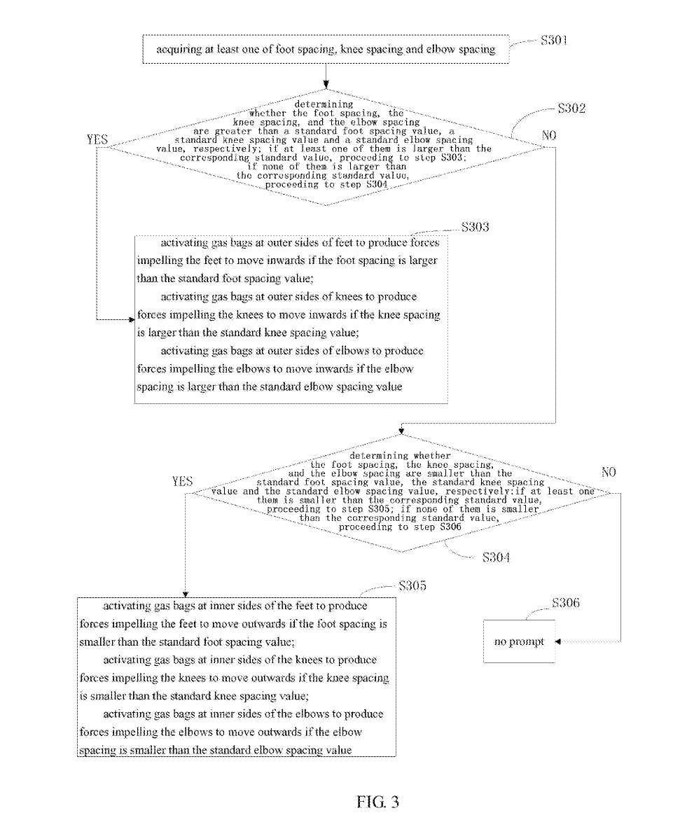

FIG. 2 is a schematic flow chart of a swimming stroke information processing method according to some embodiments of the present disclosure. As shown in FIG. 2, the swimming stroke information. processing method according to some embodiments of the present disclosure includes:

step S201, acquiring swimming stroke information at limb positions to be detected of a user; and

step S202, determining, according to the swimming stroke information, prompt information for prompting the user to adjust swimming strokes.

In the present disclosure, the limb positions to be detected of the user refer to positions, at which stroke information is collected when the user is swimming, in different parts of the limbs of the user. Due to different heights and body shapes of users, or different swimming styles (e.g., freestyle or breaststroke), specific locations of the limb positions to be detected may be different. In some embodiments, the limb positions to be detected of the user include joints, centers of palms and centers of soles.

In some embodiments, the limb positions to be detected of the user may be set by the user. For example, the user may set a position at an outer side of his/her wrist and a position, which is 20 cm above his/her knee, at an outer side of his/her thigh to be the limb positions to be detected. In some embodiments, the limb positions to be detected of the user may be set by an instruction input by the user. In some embodiments, the limb positions to be detected of the user may be set by putting an information collection device on particular parts (e.g., wrist and part at 20 cm above the knee) of the user's limbs. Considering that the limb positions to be detected set by the user may have problems such as low accuracy, in some other embodiments, the limb positions to be detected of the user may be determined automatically by a computer program. For example, the limb positions to be detected are determined automatically by acquiring body shape information of the user through infrared detection or the like and then taking the swimming style to be adopted by the user into consideration. Optionally, after acquiring the body shape information and swimming style of the user, a position determination processor for determining the limb positions to be detected makes a match in a database storing detection positions of a large number of users to determine the limb positions to be detected of the user. For example, the position determination processor determines that the limb positions to be detected of a slim female user in freestyle swimming are positions at 20 cm below top of the head and on outer sides of both arms, elbow joints, positions at 7 cm above elbow joints and on outer sides of both arms, and positions at 5 cm below elbow joints and on outer sides of elbow joints.

In the present disclosure, the swimming stroke information refers to parameters obtained from the limb positions to be detected of the user when the user is swimming, e.g., coordinates of the limb position to be detected, angle of the limb position to be detected, movement speed of the limb position to be detected, acceleration of the limb position to be detected, etc. Different limb positions to be detected correspond to different types of parameters, e.g., a parameter collected at outer sides of both arms may be coordinates of positions at the outer sides of both arms of the user or horizontal movement speed of both arms of the user; a parameter collected at the top of the user's head may be a real-time angle of the user's head with respect to a horizontal plane. Specifically, the swimming stroke information may be obtained from an electrical signal converted from a physical quantity collected by a sensor at the limb position to be detected of the user.

In some embodiments, a device (acquiring device) for acquiring the swimming stroke information is a sensor, whose position and type may be determined according to the limb positions to be detected of the user and the type of the parameter to be obtained from the limb positions to be detected of the user. In some embodiments, the user may wear an information collection device (such as a bracelet or a foot ring with built-in sensors) on the limb position to be detected. In some other embodiments, the user may wear an intelligent device (such as smart swimsuit) with built-in sensors and a position determination processor. For example, the built-in sensors of the smart swimsuit are flexible sensors that occupy an area equal to or smaller than an area of the swimsuit. In this case, after the position determination processor determines the limb positions to be detected, the position determination processor outputs an instruction to initialize the built-in sensor in the smart swimsuit, so that the built-in sensors determine, from all parts of the user's limbs attached to the built-in sensors, specific position points for collecting swimming stroke information.

After the swimming stroke information of the limb positions to be detected of the user is obtained, a prompt information determination processor determines prompt information according to the swimming stroke information, the prompt information being used for prompting the user to adjust his/her swimming strokes. Specifically, the prompt information determination processor compares the obtained swimming stroke information with stored standard swimming stroke information to determine the prompt information. In some embodiments, a swimming stroke model of the user is established according to the swimming stroke information obtained in a certain period, the established swimming stroke model is compared with the stored standard swimming stroke model, and the prompt information is determined according to the comparison result. In some embodiments, the prompt information determination processor and the sensors for collecting the swimming stroke information are integrated in a single device such as the bracelet, the foot ring or the smart swimsuit. In some other embodiments, the prompt information determination processor may be separated from the sensors for collecting the swimming stroke information, and provided in other device such as a mobile terminal (e.g., mobile phone) or a platform server providing swimming stroke adjustment service. For example, in the case where the prompt information. determination processor is provided in a mobile phone, the mobile phone receives the swimming stroke information provided by the bracelet, the foot ring or the smart swimsuit, and determines the prompt information. Optionally, the smart swimsuit (or the bracelet, or the foot ring) and the mobile phone are in wireless connection and communication.

The swimming stroke information processing method provided in the embodiments of the present disclosure can effectively collect the swimming stroke information of the user and determine the prompt information to prompt the user to adjust his/her swimming strokes.

Optionally, the limb positions to be detected include spacing detection positions and/or angle detection positions; the swimming stroke information includes spacing information associated with the spacing detection positions and/or angle information associated with the angle detection positions. Accordingly, the step of acquiring swimming stroke information of the limb positions to be detected of the user includes acquiring the spacing information and/or the angle information.

In some embodiments, the spacing detection positions include at least one of feet, knees and elbows, and the spacing information includes at least one of foot spacing, knee spacing and elbow spacing. For example, at least one of foot spacing, knee spacing and elbow spacing may be acquired by a position sensor.

In some embodiments, the angle detection positions include at least one of palms and soles, and the angle information includes at least one of palm tilt angle and sole tilt angle. For example, at least one of palm tilt angle and sole tilt angle may be acquired by an angle sensor.

In some embodiments, the angle detection positions include at least one of a first position set including elbows, forearms and upper arms, and a second position set including knees, shanks and thighs, and the angle information includes at least one of elbow bending angle information and knee bending angle information. For example, position information at each elbow, a position in each forearm and a position in each upper arm may be acquired by a position sensor, and the elbow bending angle information is determined according to the acquired position information. at each elbow, the position in each forearm and the position in each upper arm. For example, coordinates at each elbow, coordinates at a certain point in each forearm and coordinates at a certain point in each upper arm may be acquired. According to geometric principle, the three positions on one arm form a triangle, and the elbow bending angle is an included angle between a line connecting the elbow and the certain point in the forearm and a line connecting the elbow and the certain point in the upper arm. As another example, position information at each knee, a position in each shank and a position in each thigh may be acquired by a position sensor, and the knee bending angle information is determined based on the acquired position information at each knee, the position in each shank and the position in each thigh.

It should be noted that, in the embodiments of the present disclosure, the device (acquiring device) for acquiring the swimming stroke information at the limb positions to be detected of the user may be sensors, which can detect coordinates, angles, velocities, etc., of the limb positions to be detected, and are located at the limb positions to be detected. In some other embodiments, the device (acquiring device) for acquiring the swimming stroke information at the limb positions to be detected of the user may also be a device integrating a sensor device and a processing device. The sensor device detects coordinates, angles, velocities, etc., of the limb positions to be detected and then provides parameters representing the coordinates, angles, velocities, etc., to the processing device, and the processing device determines the swimming stroke information by calculation. For example, the processing device performs demise processing on the acquired angle information, does calculation on the acquired coordinates at each elbow, a position in each forearm and a position in each upper arm to obtain the elbow bending angle, does calculation on coordinates at two knees to obtain the knee spacing, etc. The device integrating the sensor device and the processing device may be located at the limb positions to be detected, which is not limited in the present disclosure. For example, the device integrating the sensor device and the processing device may cover a large area of the limbs. In some embodiments, the processing device may be provided at the back of the human body, and the sensor device may cover every limb of the human body and is mainly configured to collect coordinates, angles, velocities, etc., of the determined limb positions to be detected. The sensor device does not need to collect coordinates, angles, velocities, etc., of other positions in the limbs. Needless to say, it is not necessary to integrate the processing device in the device for acquiring the swimming stroke information of the limb positions to be detected of the user.

Optionally, the step of determining prompt information according to the swimming stroke information specifically includes: determining the prompt information according to the spacing information and/or the angle information, the prompt information being specifically used for prompting the user to adjust corresponding spacing and/or angle. The spacing information may be, for example, toot spacing between two heels, knee spacing between two knees, and elbow spacing between two elbows. After the spacing information is obtained, the obtained spacing information is provided to a prompt information determination processor for determining the prompt information, and the prompt information determination processor compares the spacing information with standard spacing values and determines the prompt information according to a comparison result so as to prompt the user to adjust and correct the swimming strokes.

Optionally, the step of determining prompt information according to the swimming stroke information specifically includes: determining a swimming stroke model of the user according to the spacing information and the angle information, and comparing the determined swimming stroke model with a standard swimming stroke model to determine the prompt information for prompting the user to adjust the spacing and/or the angle, thus adjusting and correcting the swimming strokes.

Optionally, the swimming stroke information processing method further includes: outputting the prompt information to the user. For example, a voice prompting the user to adjust the swimming strokes may be output in audio form; comparative images including the swimming strokes of the user and standard swimming strokes may be output in video form; a force for impelling the user's limbs to move closer to the standard swimming stroke may be output to adjust the user's swimming stroke. Specifically, drive mechanism for producing the force may be a gas bag.

Description will be given below in conjunction with FIG. 3 by taking the case of outputting the prompt information by means of gas bags as an example. As shown in FIG. 3, the swimming stroke information processing method includes:

step S301, acquiring foot spacing, knee spacing and elbow spacing;

step S302, determining whether the foot spacing, the knee spacing, and the elbow spacing are greater than a standard foot spacing value, a standard knee spacing value and a standard elbow spacing value, respectively; if at least one of the foot spacing, the knee spacing, and the elbow spacing is larger than the corresponding standard value, proceeding to step 5303; if none of the foot spacing, the knee spacing, and the elbow spacing is larger than the corresponding standard value, proceeding to step S304;

step S303, activating gas bags at outer sides of feet to produce forces impelling the feet to move inwards if the foot spacing is larger than the standard toot spacing value;

activating gas bags at outer sides of knees to produce forces impelling the knees to move inwards if the knee spacing is larger than the standard knee spacing value; and

activating gas bags at outer sides of elbows to produce forces impelling the elbows to move inwards if the elbow spacing is larger than the standard elbow spacing value;

step S304, determining whether the foot spacing, the knee spacing, and the elbow spacing are smaller than the standard foot spacing value, the standard knee spacing value and the standard elbow spacing value, respectively; if at least one of the foot spacing, the knee spacing, and the elbow spacing is smaller than the corresponding standard value, proceeding to step S305; if none of the foot spacing, the knee spacing, and the elbow spacing is smaller than the corresponding standard value, proceeding to step S306;

step S305, activating gas bags at inner sides of the feet to produce threes impelling the feet to move outwards if the foot spacing is smaller than the standard foot spacing value; or

activating gas bags at inner sides of the knees to produce forces impelling the knees to move outwards if the knee spacing is smaller than the standard knee spacing value; or

activating gas bags at inner sides of the elbows to produce forces impelling the elbows to move outwards if the elbow spacing is smaller than the standard elbow spacing value;

step S306, no prompt.

In the swimming stroke information processing method provided in the disclosure, swimming stroke information of the user can be effectively collected, and prompt information can be determined and output in various ways, thus effectively adjusting the swimming strokes of the user.

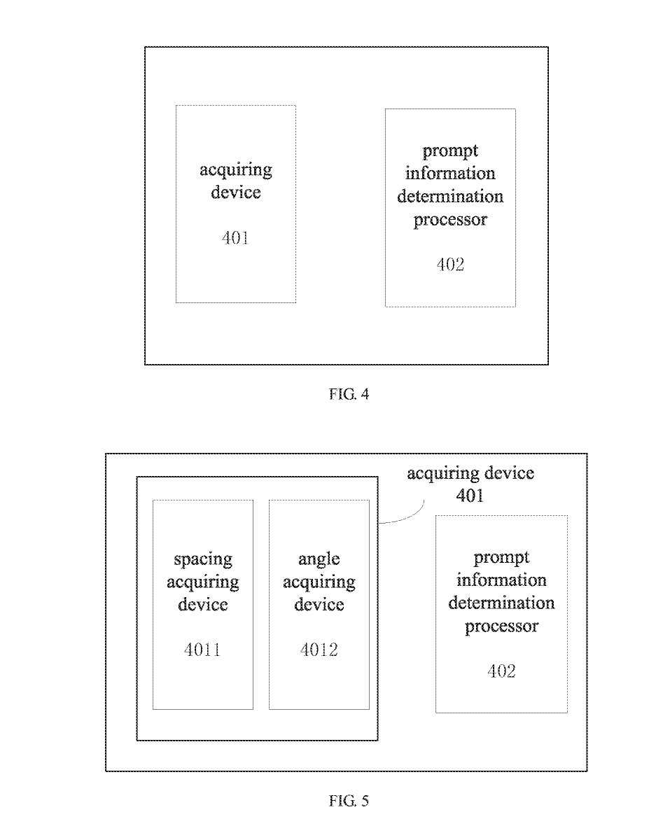

Based on the same inventive concept, the present disclosure further provides a swimming stroke adjustment device, as shown in FIG. 4, including an acquiring device 401 and a prompt information determination processor 402.

The acquiring device 401 is configured to acquire swimming stroke information of limb positions to be detected of a user.

The acquiring device may be provided at the limb positions to be detected, or other positions than the limb positions to be detected.

For example, in some embodiments, the acquiring device is specifically a sensor device provided at the limb positions to be detected. For example the acquiring device may be a sensor device placed at joints, palms and soles of the user.

For another example, in some other embodiments, the acquiring device is specifically a flexible sensor device that covers a large area of the limbs of human body. Coordinates, angles, velocities or the like during swimming can be collected in the covered area of the limbs of human body. Furthermore, the limb positions to be detected can be determined in the covered area of the limbs of human body, for example, joints, palms, soles, and positions at 20 cm above knee joints on outer sides of thighs are chosen as the limb positions to be detected.

For another example, in some other embodiments, the acquiring device specifically includes a sensor device and a processing device. The sensor device is configured to collect coordinates, angles, velocities, etc., of the limb positions to be detected during swimming, and the processing device is configured to do calculation on the collected coordinates, angles, velocities, etc., to determine the swimming stroke information. For example, the processing device may perform denoise processing on the acquired angle data, do calculation on the acquired position data at each elbow, a position in each forearm and a position in each upper arm to obtain the elbow bending angle, do calculation on coordinates at two knees to obtain the knee spacing, etc. Optionally, the acquiring device integrating the sensor device and the processing device may be provided at the limb positions to be detected. Optionally, in the acquiring device integrating the sensor device and the processing device, only the sensor device is provided at the limb positions to be detected, whereas the position at which the processing device is provided is not limited to the limb positions to be detected, for example, the processing device may be provided on the back which is not the limb position to be detected. Optionally, the processing device is electrically connected to the sensor device so as to obtain information such as coordinates, angles, velocities, etc., provided by the sensor device.

The prompt information determination processor 402 is configured to determine, according to the swimming stroke information, prompt information for prompting the user to adjust swimming strokes.

In some embodiments, the prompt information determination processor may be integrated with the sensor device or the processing device in the acquiring device, and provided in, for example, a bracelet, a foot ring, or smart swimsuit that the user wears. In some other embodiments, the prompt information determination processor is separated from the sensor device or the processing device in the acquiring device, and provided independently in other external device such as a mobile terminal (e.g., mobile phone) or a platform server providing swimming stroke adjustment service. For example, in the case that the prompt information determination processor is provided in a mobile phone, the mobile phone receives the swimming stroke information provided by the bracelet, the foot ring or the smart swimsuit, and determines the prompt information. The smart swimsuit (or the bracelet, or the foot ring) and the mobile phone are in wireless connection and communication. In this case, the swimming stroke adjustment device in the present disclosure includes a sensor device provided at the limb positions to be detected and other external device.

In the swimming stroke adjustment device provided in the disclosure, swimming stroke information of the user can be effectively collected, and prompt information can be determined and output in various ways, thus effectively adjusting the swimming strokes of the user.

In order to acquire the swimming stroke information more fully, optionally, the limb positions to be detected include spacing detection positions and/or angle detection positions, and the swimming stroke information includes spacing information associated with the spacing detection positions and/or angle information associated with the angle detection positions. As shown in FIG. 5, the acquiring device 401 includes a spacing acquiring device 4011 configured to acquire the spacing information and/or an angle acquiring device 4022 configured to acquire the angle information.

Optionally, the spacing acquiring device may be position sensors configured to acquire coordinates of a pair of spacing detection positions so as to determine a distance between the pair of spacing detection positions. The pair of spacing detection positions may be, for example, an outer side of left ankle and an outer side of right ankle. Alternatively, the position sensor directly measures the distance between the pair of spacing detection positions. Needless to say, in addition to the position sensor, the spacing acquiring device may further include a processing device for processing the spacing, which processes the acquired information to determine the swimming stroke information.

Optionally, the angle acquiring device may be angle sensors such as gyroscope or inclinometer for acquiring angle parameters at the angle detection positions. Optionally, the angle acquiring device may be position sensors, which calculates angle parameters according to the acquired position parameters. Needless to say, in addition to the position sensors or the angle sensors, the angle acquiring device may further include a processing device for processing the acquired information, which processes the acquired angle parameters, position parameters or the like to determine the swimming stroke information.

Optionally, the spacing detection positions include at least one of feet, knees and elbows, and the spacing information includes at least one of foot spacing, knee spacing and elbow spacing. Optionally, the spacing acquiring device 4011 specifically includes position sensors for acquiring at least one of foot spacing, knee spacing and elbow spacing.

In some embodiments, the position sensors serving as the spacing acquiring device are, for example, photoelectric sensors symmetrically provided at inner sides of both heels, inner sides of both knees, and inner sides of both elbows to acquire foot spacing, knee spacing and elbow spacing. Specifically, in the process of performing stroke action with limbs, the photoelectric sensors will be blocked when two limbs meet. For example, in breaststroke and butterfly swimming, when two limbs are parallel and meet under water, horizontal spacing can be measured to obtain spacing information; in freestyle and backstroke swimming, light is refracted at the surface of water, so that detected distance is mapped in the horizontal plane, thus obtaining the horizontal distance.

When the difference between the foot spacing, knee spacing or elbow spacing and the standard foot spacing value, the standard knee spacing value or the standard elbow spacing value is larger than a corresponding threshold, the prompt information determination processor may determine the prompt information to prompt the user to adjust the corresponding spacing. Further, in order to prompt the user to adjust the swimming stroke in a more intelligent way, the prompt information determination processor may activate a drive component to generate a force, which prompts the user to move the feet, knees or elbows closer to or away from each other.

In addition to the position sensors, the spacing acquiring device may further include a processor device for processing collected photoelectric signal to determine the spacing information. The processing device may be integrated in the position sensors, or may be provided independently at, for example, a position where the smart swimsuit is attached to the back of human body.

Optionally, the angle detection positions include at least one of palms and soles; and the angle information includes at least one of palm tilt angle and sole tilt angle. Optionally, the angle acquiring device 4022 specifically includes angle sensors for acquiring at least one of the palm tilt angle and the sole tilt angle.

In some embodiments, the angle sensors serving as the angle acquiring device are provided at centers of palms or centers of soles. The angle sensor is, for example, an inclinometer or a gyroscope. The gyroscope may be a three-axis gyroscope which senses position variations in three directions (x-axis, y-axis and z-axis directions) and converts them into representations of r, θ, φ in spherical coordinate system. Orientation of the palm or sole during swimming may be indicated by the azimuth angle θ, paddling angle of hand or paddling angle of foot (i.e., palm tilt angle or sole tilt angle) when the user paddles with hands and feet during swimming is determined by the included angle between the detected azimuth angle θ of the palm or sole and a preset horizontal plane. The prompt information determination processor calculates the difference between the palm tilt angle or the sole tilt angle and a standard palm tilt angle value or a standard sole tilt angle value (also referred to as “tilt angle difference”). It indicates that stroke action of the user is not standard when the difference exceeds a tilt angle difference threshold, and adjustment prompt is given. When the tilt angle difference is positive, it indicates that the palm or sole is overly extroversive, and the prompt information determination processor may activate adjustment feedback of turning inwardly; when the tilt angle difference is negative, it indicates that the palm or sole is overly introversive, and the prompt information determination processor may activate adjustment feedback of turning outwardly. Needless to say, the palm tilt angle or the sole tilt angle may be determined by calculating an included angle between an angle obtained by integrating angular velocities in x-axis, y-axis and z-axis directions detected by the three-axis gyroscope and the preset horizontal plane. Generally, the shorter the integration time, the more accurate the output angle.

In addition to the angle sensors, the angle acquiring device may further include a processing device for processing the collected angle parameters, e.g., performing denoise or digital processing, to determine the angle information. The processing device may be integrated in the angle sensors or may be provided independently at, for example, a position where the smart swimsuit is attached to the back of human body.

Optionally, the angle detection positions include at least one of a first position set and a second position set, the first position set including elbows, positions in forearms and positions in upper arms, and the second position set including knees, positions in shanks and positions in thighs; the angle information includes at least one of elbow bending angle information and knee bending angle information. Optionally, the angle acquiring device 4022 specifically includes position sensors for acquiring position information at each elbow, a position in each forearm and a position in each upper arm, and determining the elbow bending angle information; and/or for acquiring position information. at each knee, a position in each shank and a position in each thigh and determining the knee bending angle information.

Optionally, the position sensors serving as the angle acquiring device are configured to acquire coordinates at each elbow, a certain point in each forearm and a certain point in each upper arm. According to geometric principle, the three positions on one arm form a triangle, and the elbow bending angle is an included angle formed by taking the elbow as the vertex and the forearm and the upper arm as two sides. As another example, the position sensors serving as the angle acquiring device are configured to acquire position information at each knee, a position in each shank and a position in each thigh to determine the knee bending angle information. The angle acquiring device may include photoelectric sensors for acquiring the real-time distance between a certain point in the upper arm and a certain point in the forearm, and determining the elbow bending angle according to a fixed distance between the elbow and the certain point in the upper arm and a fixed distance between the elbow and the certain point in the forearm. The same principle applies to the knee bending angle.

The certain point in the upper arm may be any position in the upper arm including a connecting point between the upper arm and the shoulder, and the certain point in the forearm may be any position in the forearm including a connecting point between the forearm and the palm.

Optionally, the prompt information determination processor 402 is specifically configured to determine, according to the spacing information and/or the angle information, the prompt information for prompting the user to adjust the corresponding spacing and/or angle.

For example, when determining that the difference between the foot spacing, the knee spacing or the elbow spacing and the standard foot spacing value, the standard knee spacing value or the standard elbow spacing value is beyond the corresponding threshold range, the prompt information determination processor determines the prompt information to cause the user to adjust the corresponding spacing when swimming. Further, in order to prompt the user to adjust the swimming stroke in a more intelligent way, the prompt information determination processor may activate a drive component to generate a force, which prompts the user to move the feet, knees or elbows closer to each other, when the foot spacing, the knee spacing or the elbow spacing measured by the position sensors is larger than the standard foot spacing value, the standard knee spacing value, or the standard elbow spacing value; the prompt information determination processor may activate the drive component to generate a force, which prompts the user to move the feet, knees or elbows away from each other, when the foot spacing, the knee spacing or the elbow spacing measured by the position sensors is smaller than the standard foot spacing value, the standard knee spacing value, or the standard elbow spacing value.

For example, the prompt information determination processor calculates the difference between the palm tilt angle or the sole tilt angle and the standard palm tilt angle value or the standard sole tilt angle value (also referred to as “tilt angle difference”). When the difference is beyond the corresponding threshold range, it indicates that stroke action of the user is not standard and it is necessary to prompt the user to adjust swimming strokes. When the tilt angle difference is positive, it indicates that the palm or sole is overly extroversive, and the prompt information determination processor may activate adjustment feedback of turning inwardly; when the tilt angle difference is negative, it indicates that the palm or sole is overly introversive, and the prompt information determination processor may activate adjustment feedback of turning outwardly.

It needs to be noted that the standard values associated with spacing and the standard values associated with tilt angle each may be a value, or a numerical range.

Optionally, the prompt information determination processor 402 is configured to determine a swimming stroke model of the user according to the spacing information and/or the angle information, and compare the determined swimming stroke model with a standard swimming stroke model to determine the prompt information for prompting the user to adjust the corresponding spacing and/or angle.

For example, the prompt information determination processor 402 simulates, according to the acquired trot spacing, knee spacing, elbow spacing, palm tilt angle, sole tilt angle, knee bending angle, elbow bending angle, and the like in conjunction with limb information of human body, limb movement trajectory to establish the swimming stroke model of the user, compares the established swimming stroke model with the standard swimming stroke model, for example, extracts coordinates in the standard swimming stroke model and coordinates in the established swimming stroke model and does calculations to determine adjustment direction, adjustment distance or adjustment angle of a corresponding limb position of the user, so as to determine the prompt information. Further, the standard swimming stroke model may serve as a background model, the established swimming stroke model may serve as a foreground model, and the prompt information determination processor performs joint fusion on the background model and the foreground model and determines coordinate matching degrees of the respective joints by analyzing relative positions of the coordinates, so as to determine the prompt information.

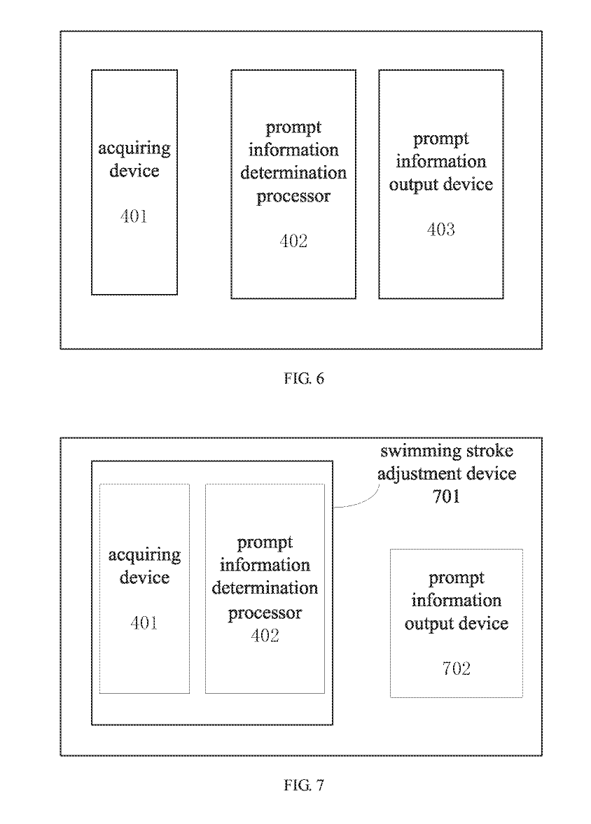

Optionally, as shown in FIG. 6, the swimming stroke adjustment device further includes a prompt information output device 403 configured to output the prompt information to the user.

Optionally, the prompt information output device 403 includes an audio output device, which outputs a voice prompting the user to adjust swimming strokes in audio form, so that the user can timely adjust swimming strokes after hearing the voice. The prompt information output device may be provided in the smart swimsuit and electrically connected to the prompt information determination processor.

Optionally, the prompt information output device 403 includes drive mechanism configured to generate, according to the prompt information, a force impelling the user's limbs to move in the direction indicated by the standard swimming stroke, so that the user adjusts the swimming strokes.

Considering that the voice reception of the user may be affected when swimming, the prompt information output device 403 specifically includes drive mechanism such as gas bags or pressure gauges provided at limbs of the user, and the gas bags or the pressure gauges may be integrated in the smart swimsuit or may be independent gas bags or pressure gauges that the user wears.

For example, mini gas bags are provided at various positions of the swimsuit, such as positions corresponding to elbow joints, knee joints, upper arms and forearms. When the prompt information determination processor determines that the swimming stroke information acquired by the acquiring device and the corresponding standard value do not match, the gas bags inflate to generate forces impelling the user's limbs to move closer to the standard swimming stroke. For example, in the case where gas bags are provided at both inner and outer sides of the elbow of human body, when the prompt information indicating that the elbow needs to be adjusted outwardly is determined, the gas bag provided at the inner side inflates to impel the elbow to move outwardly; when the prompt information indicating that the elbow needs to be adjusted inwardly is determined, the gas bag provided at the outer side inflates to impel the elbow to move inwardly.

Further, in order to improve adjustment accuracy of the gas bag, for example, the acquiring device acquires real-time elbow spacing and provides the elbow spacing to the prompt information determination processor when the gas bag impels the elbow to move outwardly or inwardly, and the prompt information determination processor adjusts, according to the real-time data of elbow spacing, gas bag expansion coefficient, thus achieving more accurate adjustment to swimming strokes.

For another example, pressure gauges may be provided at various positions of the smart swimsuit to generate forces that press the human body so that the user can perceive swimming stroke adjustment direction. At the same time, pressure sensors may be provided at various positions of the smart swimsuit. The pressure gauges are adjusted by the prompt information determination processor to generate pressing forces that allow the user to perceive adjustment direction, and in the meanwhile, the pressure sensors obtain real-time pressure values applied by the pressure gauges and feed them back to the prompt information determination processor, thus controlling strengths of the pressure gauges in real time.

Based on the same inventive concept, the present disclosure further provides a swimming stroke information processing system. As shown in FIG. 7, the system includes any swimming stroke adjustment device 701 described above, and a prompt information output device 702 in wireless or wired connection with the swimming stroke adjustment device 701. In the embodiment, different output form of the prompt information may be chosen depending on different prompt information output device, and this has a more flexible effect.

Optionally, output of the prompt information output device may be, for example, in the form of video, image, force, voice, or the like. Specifically, the prompt information output device may be at least one of a display device, a drive device and an audio device.

The display device may be, for example, intelligent goggles, a display, a smart phone, or the like, which has a display function.

For example, intelligent goggles having transparent display function can acquire the prompt information provided by a wearable smart device (e.g., the bracelet, the foot ring, or the smart swimsuit), and the swimming strokes of the user and the standard swimming strokes are displayed in the transparent display screen in the goggles. For another example, a large display provided in front of the pool may obtain the prompt information provided by the wearable smart device, and display the swimming strokes of the user and the standard swimming strokes in the big screen thereof. For still another example, the display device may be a smart phone, for example, the swimming coach of the user can view images of swimming strokes of the user from the smart phone and convey, according to the images of swimming strokes, swimming stroke adjustment instructions to the user, and the user can also view images of his/her swimming strokes from the smart phone after swimming to summarize his/her own problems of non-standard swimming strokes in swimming.

Further, the display device may display the standard swimming stroke model and the swimming stroke model of the user in different colors. For example, in swimming, intelligent goggles simultaneously display both the standard swimming stroke model and the swimming stroke model of the user. The standard swimming stroke model is taken as the background model, the swimming stroke model of the user is taken as the foreground model, and the prompt information determination processor performs joint fusion on the background model and the foreground model and determines coordinate matching degrees of the respective joints by analyzing relative positions of the coordinates. If actual joint coordinates and joint coordinates of the standard swimming stroke do not match, the prompt information determination processor determines the corresponding prompt information and provides it to the intelligent goggles, so that the intelligent goggles display prompt regarding corresponding joint in the display area and identify the part performing non-standard actions by changing its color.

The drive device is configured to generate, according to the prompt information, a force for impelling the user's limbs to move closer to the standard swimming stroke, thus allowing the user to adjust the swimming strokes.

For example, the gas has with signal reception function inflates according to the prompt information upon receipt of the prompt information.

The audio device is configured to generate, according to the prompt information, voice information for informing the user of incorrect swimming stroke, so that the user can adjust the swimming stroke. For example, a smart watch with voice prompt function issues, according to the prompt information, a voice informing the user of incorrect swimming stroke, upon receipt of the prompt information.

It should be note that, in the present disclosure, devices, apparatuses, means, and modules provided at various positions of the user's limbs are subject to waterproofing process. Needless to say; the devices, apparatuses, means, and modules may be sewed in the smart swimsuit made of a waterproof material.

The swimming stroke adjustment device described in the present disclosure is a device for implementing the swimming stroke information processing method provided in the present disclosure, and is thus based on the swimming stroke information processing method described in the present disclosure. A person skilled in the art can understand specific implementations and various variants of the swimming stroke adjustment device of the embodiments, and thus, detailed description on how the swimming stroke adjustment device implements the swimming stroke information. processing method in the present disclosure will not be given herein. All devices that are adopted to implement the swimming stroke information processing method in the present disclosure by a person skilled in the art should fall into the scope to be protected by this application.

Many functional units described in this specification are labeled as modules, in order to further emphasize their implementation independence. For example, a module may be implemented as a hardware circuit comprising custom VLSI circuits or hardware circuits of gate arrays, and existing semiconductors such as logic chips, transistors, or other discrete components. Modules may be implemented by, for example, field programmable gate arrays, programmable array logic, programmable logic devices or the like. Modules may also be implemented by software for execution by various types of processors. An identified module of executable code may, for example, comprises one or more physical or logical blocks of computer instructions, and the blocks may be organized as an object, procedure, function, or other configuration. However, the executable codes of an identified module need not be physically located together, but may comprise disparate instructions stored in different locations which, when these instructions are logically connected together, constitute the module and achieve the stated purpose of the module. Indeed, a module of executable code may be a single instruction, or many instructions, and may even be distributed over several different code segments, among different programs and across several memory devices. Similarly, operational data may be identified and illustrated herein within modules, and may be implemented in any suitable form and organized within any suitable type of data structure. Operational data may be concentrated into a single data set, or may be distributed over different locations including over different storage devices, and may exist at least partially, merely as electronic signals on a system or network.

It can be understood that, the above implementations are merely exemplary implementations used for explaining the principle of the present invention, but the present invention is not limited thereto. For those skilled in the art, various modifications and improvements may be made without departing from the spirit and essence of the present invention, and these modifications and improvements are also deemed as falling within the protection scope of the present invention.

1. A swimming stroke adjustment device, comprising:
an acquiring device, configured to acquire swimming stroke information of limb positions to be detected of a user, and
a prompt information determination processor, configured to determine, according to the swimming stroke information, prompt information for prompting the user to adjust swimming strokes.

2. The swimming stroke adjustment device of claim 1, wherein,
the prompt information determination processor is configured to determine a swimming stroke model of the user according to the swimming stroke information, and compare the determined swimming stroke model with a standard swimming stroke model to determine the prompt information.

3. The swimming stroke adjustment device of claim 2, wherein,
the acquiring device comprises a spacing acquiring device for acquiring a spacing between the limb positions to be detected.

4. The swimming stroke adjustment device of claim 2, wherein,
the acquiring device comprises an angle acquiring device for acquiring an angle at the limb position to be detected.

5. The swimming stroke adjustment device of claim 3, wherein,
the limb positions to be detected comprise at least one of feet, knees and elbows;
the spacing acquiring device is configured to acquire at least one of foot spacing, knee spacing and elbow spacing; and
the prompt information is used for prompting the user to adjust at least one of the foot spacing, the knee spacing and the elbow spacing.

6. The swimming stroke adjustment device of claim 4, wherein,
the limb positions to be detected comprise at least one of palms and soles;
the angle acquiring device is configured to acquire at least one of a palm tilt angle and a sole tilt angle; and
the prompt information is used for prompting the user to adjust at least one of the palm tilt angle and the sole tilt angle.

7. The swimming stroke adjustment device of claim 4, wherein,
the angle acquiring device is configured to acquire at least one of elbow bending angle information and knee bending angle information, and
the prompt information is used for prompting the user to adjust at least one of an elbow bending angle and a knee bending angle.

8. The swimming stroke adjustment device of claim 7, wherein,
the angle acquiring device is configured to: acquire position information at each elbow, a position in each forearm and a position in each upper arm and determine the elbow bending angle information based on the acquired position information at each elbow, the position in each forearm and the position in each upper arm; and/or acquire position information at each knee, a position in each shank and a position in each thigh and determine the knee bending angle information based on the acquired position information at each knee, the position in each shank and the position in each thigh.

9. A swimming stroke information processing system, comprising the swimming stroke adjustment device of claim 1 and a prompt information output device connected to the swimming stroke adjustment device.

10. The swimming stroke information processing system of claim 9, wherein, the prompt information determination processor is configured to determine a swimming stroke model of the user according to the swimming stroke information, and compare the determined swimming stroke model with a standard swimming stroke model to determine the prompt information.

11. The swimming stroke information processing system of claim 10, wherein,
the prompt information output device comprises one or more of a display device, a drive device and an audio device;
the display device is configured to display, according to the prompt information, comparative images comprising the determined swimming stroke model of the user and the standard swimming stroke model to the user, so that the user adjusts the swimming strokes according to the comparative images;
the drive device is configured to generate, according to the prompt information, a force for impelling limbs of the user to move in a direction indicated by the standard swimming stroke model, so that the user adjusts the swimming strokes; and
the audio device is configured to generate, according to the prompt information, voice information for informing the user of incorrect swimming stroke, so that the user adjusts the swimming strokes.

12. A swimming stroke information processing method, comprising steps of:
acquiring swimming stroke information of limb positions to be detected of a user, and
determining, according to the swimming stroke information, prompt information for prompting the user to adjust swimming strokes.

13. The swimming stroke information processing method of claim 12, wherein, the step of determining the prompt information. according to the swimming stroke information comprises: determining a swimming stroke model of the user according to the swimming stroke information, and comparing the determined swimming stroke model with a standard swimming stroke model to determine the prompt information.

14. The swimming stroke information processing method of claim 13, wherein, the step of acquiring swimming stroke information of limb positions to be detected of the user comprises: acquiring a spacing between the limb positions to be detected.

15. The swimming stroke information processing method of claim 13, wherein, the step of acquiring swimming stroke information of limb positions to be detected of the user comprises: acquiring an angle at the limb position to be detected.

16. The swimming stroke information processing method of claim 14, wherein,
the limb positions to be detected comprise at least one of feet, knees and elbows;
the step of acquiring swimming stroke information of limb positions to be detected of the user comprises: acquiring at least one of foot spacing, knee spacing and elbow spacing; and
the prompt information is used for prompting the user to adjust at least one of the foot spacing, the knee spacing and the elbow spacing.

17. The swimming stroke information processing method of claim 15, wherein,
the limb positions to be detected comprise at least one of palms and soles;
the step of acquiring swimming stroke information of limb positions to be detected of the user comprises: acquiring at least one of a palm tilt angle and a sole tilt angle; and
the prompt information is used for prompting the user to adjust at least one of the palm tilt angle and the sole tilt angle.

18. The swimming stroke information processing method of claim 15, wherein,
the step of acquiring swimming stroke information of limb positions to be detected of the user comprises: acquiring at least one of elbow bending angle information and knee bending angle information, and
the prompt information is used for prompting the user to adjust at east one of an elbow bending angle and a knee bending angle.

19. The swimming stroke information processing method of claim 18, wherein,
the step of acquiring swimming stroke information of limb positions to be detected of the user comprises: acquiring position information at each elbow, a position in each forearm and a position in each upper arm and determining the elbow bending angle information based on the acquired position information at each elbow, the position in each forearm and the position in each upper arm; and/or acquiring position information at each knee, a position in each shank and a position in each thigh and determining the knee bending angle information based on the acquired position information at each knee, the position in each shank and the position in each thigh.

20. The swimming stroke information processing method of claim 12, further comprising:
outputting the prompt information to the user in at least one of the following ways:
outputting the prompt information in audio form;
outputting the prompt information in video form; and
outputting a force for impelling limbs of the user in a direction indicated by the standard swimming stroke model.
